(19) United States
(12) Patent Application Publication
(10) Pub. No.: US 2009/0166243 A1
(43) Pub. Date: Jul. 2, 2009

(54) MAGNETIC PILL DISPENSER

(76) Inventor: Carl Cetera, Tenafly, NJ (US)

Correspondence Address: THE SONI LAW FIRM, 35 North Lake Ave., Suite 720, PASADENA, CA, 91101, US

(21) Appl. No.: 11/967,992

(22) Filed: Dec. 31, 2007

(51) Int. Cl. A61J 1/03; B65D 21/024

(52) U.S. Cl. 206/528; 206/459.5; 220/23.4

(57) ABSTRACT

A magnetic pill dispenser consisting of a plurality of modular pill cases configured to be magnetically attachable to one another to form an arbitrary array tailored to a user's schedule of administrating medications, or to an external ferromagnetic surface, such as a refrigerator door. Each pill case has two substantially planar parallell walls and a plurality of boundary walls one of which is openable. In the preferred embodiment, two strips of permanent magnet and ferromagnetic material configured to mateably engage each other are formed respectively on the two parallel walls so that any two cases can be magnetically connected thereby. Similar magnetic strips may be formed on one or two boundary walls for further magnetic attachment to a ferromagnetic external surface or other pill cases. On the openable wall of each case, a day-of-the-week indicator and a time-of-day indicator are imprinted for facilitating orderly, scheduled administration of medication.

The present invention relates to the field of medication dispensers having labeled pill cases that are magnetically and removably attachable to one another and an exterior surface for effective scheduled administration of medications.

### CROSS-REFERENCE TO RELATED APPLICATION

(Not Applicable)

### STATEMENT RE: FEDERALLY SPONSORED RESEARCH/DEVELOPMENT

(Not Applicable)

### BACKGROUND OF THE INVENTION

Medical dispensers are widely used for assisting administration of prescribed medications. Many dispensers have multiple compartments for storing medications therein. Each of the compartment may store different medications therein, or as is the common case, it can contain a combination of several pills to be taken at a single administration of medication, in which case, a label indicating administration time or contents of medication is usually attached on each compartment. The frequency and content of administration of medications varies depending on different prescriptions. One may need to take pills once, twice, three times, or more times a day. The medications to be taken at each administration may consist of same or different combination of pills, or sometimes different quantity of the same pills.

Therefore, for efficient administration of medications, it would be advantageous if compartments of a medication dispenser are capable of being easily arranged to form a sequential array as necessary to in accordance with a given particular administration schedule. It would be further advantageous if such an array of compartments can be easily modified as the prescription or administration schedule changes. It would yet be helpful if such an array of pill compartments can be attached, securably but detachably, to any suitable flat exterior surface, even a vertical one. Moreover, it would be still helpful if any of the pill compartments can be easily separable from such an array and conveniently carried securely in a pocket or handbag of a user during a travel, for example.

There are quite a few pill dispensers in the field comprising multiple compartments each of which is labeled to aid a scheduled administration of medications. But such pill dispensers are structured to put a substantial limitation on where to place it. Further, each of the pill compartment in such dispensers are not structured to be easily separable from, and conveniently rearrangeable with, one another to form an array tailored to a specific administration schedule. Thus, such a dispenser, commonly being of a considerable size, not only fails to provide a flexibility in its location, but also take up a considerable space. U.S. Pat. No. 4,084,695 discloses a partitioned pill box to form multi-compartments where each compartment has a removable transparent cover to provide access therein. Those compartments are, however, not separable. U.S. Pat. No. 6,102,855 discloses a pill dispenser having multiple open compartments and removable liners therein which are mounted on a removable tray with a cover. Although the liners in this invention are separately removable from the tray, they are not suitable for carrying them out because each liner does not have a separate closure on it for preventing spillage of pills therein. Further, those liners or compartments cannot be arbitrarily and securably arrayed depending on prescription schedules. U.S. Pat. No. 6,206,493 discloses a plurality of separable modular compartments for storing collectibles therein that are annularly connected to a central structure of a tubular-column shape via male/female-type catch components. The separable modular compartments, though can be used for storing and dispensing pills, cannot form an arbitrary, stable array suited for a particular prescription schedule. Also, all aforementioned prior inventions require a separate housing or structure for holding the entire multiple compartments, and thus, cannot be located on any convenient surface, such as a refrigerator door.

Therefore, it is desirable to provide a medication dispenser comprising a number of separate pill compartments to store therein an individual unit of prearranged medications to be administered at a time. It is also desirable that each of the pill compartments is labeled by, preferably, a time-of-day indicator and a day-of-the-weeks indicator to facilitate organized and scheduled administration of medications. It is yet desirable that those compartments are easily attachable to and detachable from one another so as to form various different types of arrays individualized for a particular prescription schedule given, which are easily modifiable following change of prescription schedules. It is yet desirable that when the pill compartments are in such an array, the inside of each compartment is conveniently and separately accessible for taking out the medications therein, and further, that any compartment in a array can be smoothly separated from the array for carrying it out with the user without disturbing the rest of compartments to break up the whole array. It is further desirable that the pill compartments, while stably maintaining a given array, are removably attachable to any conveniently accessible exterior surface, such as a refrigerator door.

### SUMMARY OF THE INVENTION

The present invention provides a magnetic pill dispenser having a plurality of modular pill cases that are easily and conveniently attachable to and detachable from one another or an external surface, such as a refrigerator door, via magnets and ferromagnetic material formed therebetween. Using at least one permanent magnet formed on each pill case, a user can form a specific array of the pill cases as necessary and desired, either in series or in parallel, which may be tailored to a particular prescription schedule. The user can also arbitrarily take out a pill case from the array without having to break the entire array and carry it out with herself or himself for later administration of medications therein.

The magnetic pill dispenser made in accordance with the present invention is largely comprised of a plurality of identically sized and configured pill cases. Each pill case has two substantially planar parallelly opposing walls to be used for serial connection among the cases and a plurality of boundary walls that are contiguous and substantially perpendicular to the parallel walls to define an interior of the case therewith. The number of the boundary walls depends on the particular shape of the case in different embodiments. One of the boundary walls is configured to be openable, preferably, forming a flap hingedly connected to the case at an edge, to provide an access to the interior of the case. In the preferred embodiment, each case in the dispenser is configured to be magnetically attachable to another case to form an arbitrary array as desired, or to an exterior ferromagnetic surface such as a refrigerator door.

In the first preferred embodiment, the two opposed parallel walls of each case, the right and left walls, are configured such that the right wall of one case is magnetically and detachably attachable to the left wall of another case, and vice-versa. Such connection can be achieved by attaching a permanent magnet and a ferromagnetic material such as steel, preferably both in the shape of a thin strip, on the right and left walls respectively. The strip of a permanent magnet may slightly protrudes from the right wall, which may be mateably engage the strip of ferromagnetic material attached to a bottom of a recess defined on the left wall. Via those strips, the pill cases can be consecutively connected to form a serial array with the openable lid symmetrically positioned on a side.

In the second preferred embodiment, for each of the case, a strip of a permanent magnet may be attached to a wall, say, a bottom wall, generally opposing the openable flap for magnetically attaching the case to a ferromagnetic external surface. Such a magnetic strip on the bottom wall may exist on top of those two magnetically connectible parallel walls in the first preferred embodiment. Further, in the first and second embodiments, another strip of a permanent magnet may be attached to one of the side walls, say, the rear wall, which is contiguous and perpendicular to the openable flap such that any two pill cases can be thereby parallelly connected to each other. Then, if pill cases are connected via the two parallel walls in the first preferred embodiment to form two serial arrays, those arrays may be parallelly attached to each other via the rear walls of each pill case.

For facilitating orderly, scheduled administration of medication, a time-of-day indicator such as letters “AM” and “PM”, and a day-of-the-week indicator such as “S”, “M”, “T”, “W”, “T”, “F”, and “S”, may be disposed, preferably by imprinting, on the openable flap in each case in all preferred embodiments described above.

One of the biggest advantage of the present invention in using the magnetically attachable pill cases is that a user is capable of forming and modifying various different types of arrays of pill cases specifically tailored to an individual prescription schedule. Another advantage is that any case in such a scheduled array can be easily and conveniently separated from the rest and carried out with the user without having to break up the array. Still another advantage of the present invention is that such a scheduled array of multiple pill cases can be attached to any convenient magnetically permeable surface of ferromagnetic material, even a vertical surface, like a door or refrigerator, thereby saving space and increasing flexibility in locating the medical dispenser.

Finally, the pill cases in the present invention could be used as a vehicle for advertising as well. In the preferred embodiment, the pill dispenser may include at least two pill cases in which, unlike other pill cases, one of the two opposing parallel walls does not have any permanent magnet or ferromagnetic material formed thereon. Advertising materials may be imprinted on the clean, free wall of each of those two cases so that it may be visible when the two cases are placed at two outermost ends of a serial array.

### BRIEF DESCRIPTION OF THE DRAWINGS

FIG. 1 is a perspective view of the magnetic pill case made according to the present invention, showing the right wall having a permanent magnet strip;

FIG. 2 is a perspective view of the magnetic pill case made according to the present invention, showing the left wall having a strip of ferromagnetic material and the rear wall having a permanent magnet strip;

FIG. 3 is a perspective view of the magnetic pill case made according to the present invention, showing advertising material imprinted on the right wall;

FIG. 4 is a bottom plan view of the magnetic pill case made according to the present invention, showing the bottom wall having a permanent magnet strip;

FIG. 5 is a perspective view of an array of magnetic pill cases formed according to the present invention, showing the cases being magnetically interconnected serially in a longitudinal direction as well as parallelly in a transverse direction; and

FIG. 6 is a top plan view of magnetic pill cases formed according to the present invention in a serial array, which can be formed on an external ferromagnetic surface via the permanent magnet strip on the bottom wall of each case as shown in FIG. 4.

### DETAILED DESCRIPTION OF THE INVENTION

The present invention generally relates to a magnetic pill dispenser comprising a plurality of modular pill cases that are configured to be magnetically attachable to and detachable from one another or an external surface such as a refrigerator door, to form an array specific to a particular administration schedule of medications.

Several preferred embodiments of the present invention will now be described with reference to FIGS. (‘FIGS.’) 1-6, wherein like components are designated by like reference numerals throughout the figures. Although the present invention is generally described in terms of the preferred embodiments, it should be understood that it is shown and described, only by way of illustration of the best mode contemplated in carrying out the invention, but not intended to limit in any way the spirit and scope of the invention to the particular embodiments described.

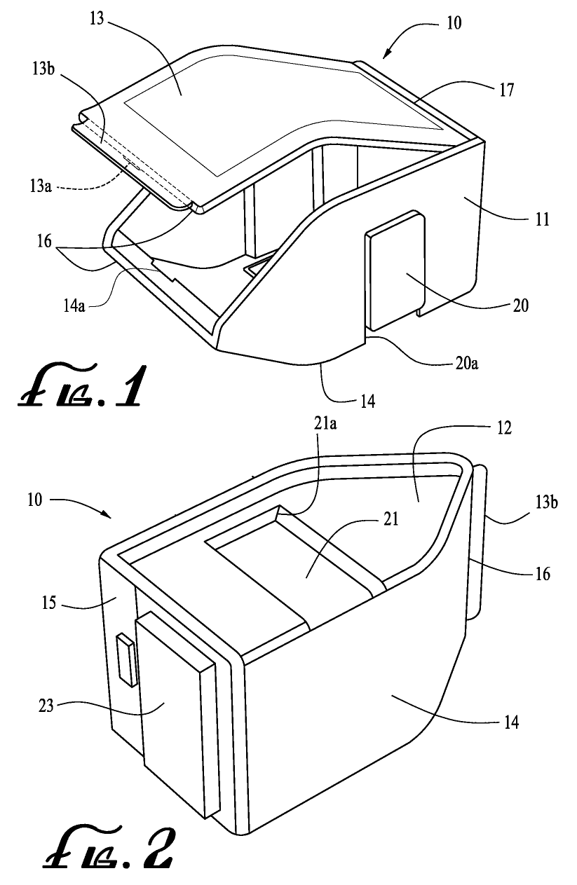

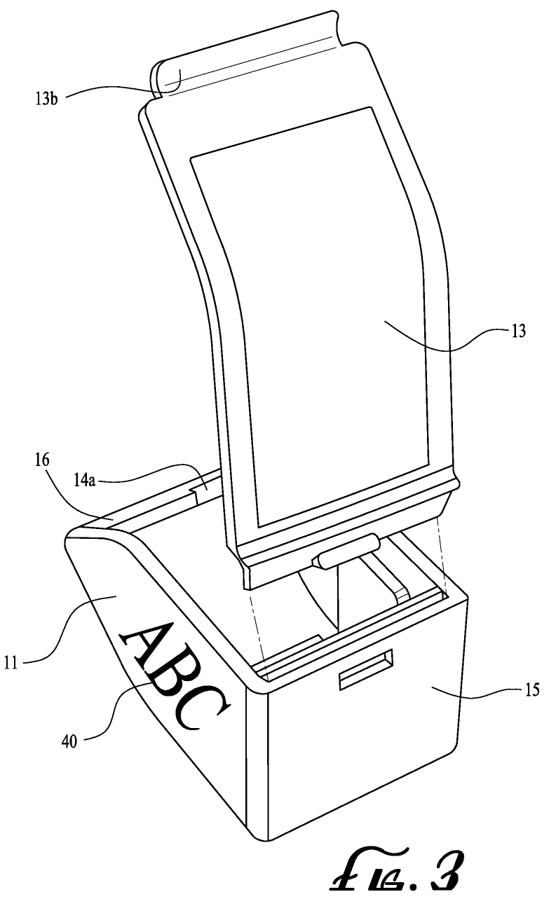

Now referring to FIGS. 1 and 2, the magnetic pill case 10 constituting a module of the pill dispenser in the present invention comprises, in the preferred embodiment, two substantially planar parallelly opposing walls, the right wall 11 and left wall 12, and a plurality of boundary walls, which define an interior of the pill case to store pills therein. In the preferred embodiment, the pill case 10 has three boundary walls, namely, the top wall 13, the bottom wall 14, and the rear wall 15, wherein the top wall 13 and bottom wall 14 have generally opposing, substantially flat portions, and contiguous thereto, smoothly curved portions which meet each other at an edge 16. The rear wall 15 is preferably substantially perpendicular to the right and left walls 11 and 12, and to the substantially flat portions of the top and bottom walls 13 and 14. Although the pill case 10 has the particular shape in the preferred embodiment as depicted in other embodiments, it may have a shape of, for example, a generally rectangular box having four boundary walls perpendicular to the right and left walls, or any other multi-facial box shape having more than four boundary walls (not shown).

The walls of the pill case 10 is fabricated of, preferably, plastic material, but it could be made of other polymeric, synthetic material, or any other suitable rigid or semi-rigid material recognized by one skilled in the art. Further, the walls could be transparent, translucent, or even opaque.

The top wall 13 forms, preferably, a flap 13 hingedly openable about an edge 17, opposed to the edge 16, for providing access to the interior of the case 10. Preferably, the flap 13 is made as a separate piece for separately disposing advertising material thereon, which is then hingedly connected to the edge 17 as shown in FIGS. 1 and 2. But it may be integrally formed with the rest of the walls of the case 10 in another embodiment. In the preferred embodiment, for secure closure of the case 10, the flap 13 may have a detent 13a formed at an end thereof opposed the edge 17 and the bottom wall 14 has a matching recess 14a on an end adjacent the edge 16, which are positioned and configured such that the detent 13a can be snap-fitted into the recess 14a when the flap 13 closes upon the bottom wall 14. Further, to facilitate lifting the flap 13 up with a user's finger in opening the case 10, the flap 13 may have a thumb plate 13b which protrudes slightly upwardly and outwardly from the edge 16 when the flap 13 is in a closed position.

The pill case 10 in the present invention is configured to be magnetically attachable to an exterior surface, including a wall of another identical pill case. In the first preferred embodiment, the right wall 11 has a thin strip of a permanent magnet 20 attached thereto and the left wall 12 has a thin strip made of ferromagnetic material 21, such as iron or steel, attached thereto at a position symmetric to that of the strip of a permanent magnet 20 so that when the right wall 11 of one pill case is placed against the left wall 12 of another identical pill case side by side, the strip of a permanent magnet 20 can attract and magnetically engage with the strip of ferromagnetic material 21. The strips 20 and 21 may be attached to the respective wall by conventional adhesives or by any other fastening means known in the art.

For secure connection, the two walls 11 and 12 may be configured to be mateably engaged with each other. For that, in the preferred embodiment, the permanent magnet strip 20 slightly protrudes from the right wall 11, acting as a male connector, and the ferromagnetic strip 21 resides at a bottom of a recess 21a defined on the left wall 12, which, having a shape and depth to tightly fit the permanent magnet strip 20 therein, acts as a female connector. With such mated engagement, the right and left walls of two pill cases can be tightly connected, wall to wall, without leaving a space between them. Such mated engagement resists against any disengaging force applied to the cases in a direction parallel to the attached walls 11 and 12, and thus, prevents the cases from being slidingly disengaged from each other.

Further, in order to permit the cases to be slidingly disengaged from each other in a particular direction, say, toward the bottom wall 14, in the preferred embodiment the permanent magnet strip 20 may be seated within a recess 20a on the right wall 11, identically sized and configured as the recess 21a on the left wall 12, where both recesses 20a and 21a extend to an edge formed by the respective intersection of the right and left walls with the bottom wall. Then, any two magnetically attached pill cases via the strips 20 and 21 can be separated from each other either by pulling the two cases apart in opposite directions, perpendicular to the attached walls 11 and 12, or by slidingly pushing one case toward the bottom wall 14 with respect to the other case.

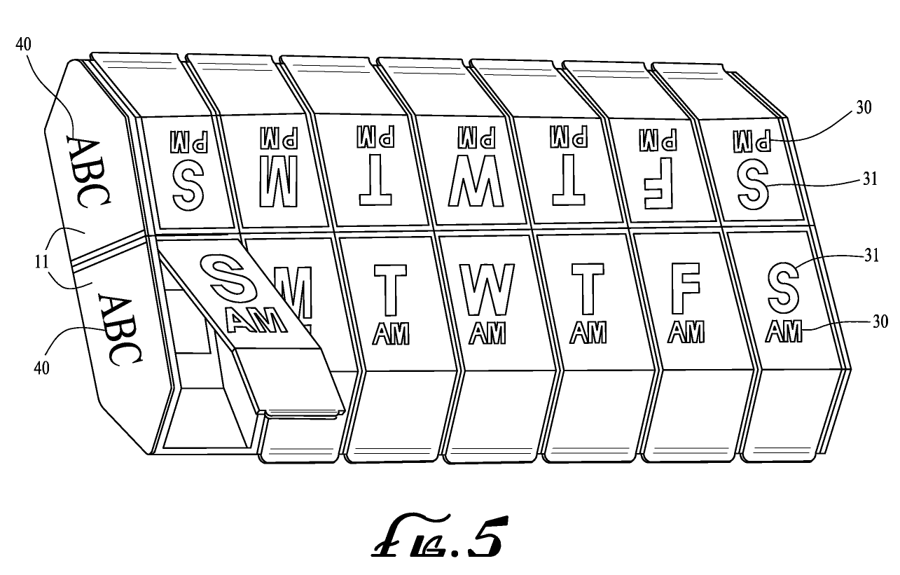

Using the permanent magnet strip 20 and the ferromagnetic strip 21 described above, a user can consecutively connect as many pill cases as may be necessary to form a serial array of the pill cases specifically tailored to a particular prescription schedule. FIG. 5 shows that two such serial arrays being arranged, side by side, but facing opposite directions. The user can arbitrarily and easily separate a particular pill case out of the array by pushing the case toward the bottom wall 14 thereof without having to break the entire array so as to take it with herself or himself for later administration of medications contained therein.

For facilitating orderly, scheduled administration of medication, as shown in FIGS. 5 and 6 in the preferred embodiment, a time-of-day indicator 30 such as letters “AM” and “PM”, and a day-of-the-week indicator 31 such as “S”, “M”, “T”, “W”, “T”, “F”, and “S”, are disposed, preferably by imprinting, on the flap 13 in each pill case 10. In the preferred embodiment, the magnetic pill dispenser comprising particularly arrayed plurality of pill cases includes at least one case that carries the day-of-the-week indicator 31 that symbolically represents each of the seven days of a week. In another embodiment, the pill dispenser may comprise at least two cases that carry the day-of-the-week indicator symbolically representing each of the seven days of a week, one of which carries the time-of-day indicator “AM”, and the other “PM”. FIG. 5 shows a pill dispenser formed in such an embodiment, comprising 14 pill cases with each having a different combination of the day-of-the-week indicator and time-of-day indicator.

When a plurality of pill cases is serially connected to form an array, two pill cases that are to be placed at two outermost ends of the array need not have any strip, whether the permanent magnet strip 20 or the ferromagnetic strip 21, formed on the two outermost facing walls 11a and 12a of the array. As shown in FIG. 5, such two outermost walls can be used as a surface to place advertising material 40. In the preferred embodiment, the medical dispenser in a form of specifically arrayed plurality of pill cases includes at least one pill case which has the permanent magnet strip 20 on its right wall 11 and nothing on the left wall 12, and at least one case which has the ferromagnetic strip 21 on its left wall 12 but nothing on its right wall 11. FIG. 3 shows one of such at least one pill case, displaying the right wall 11 on which no strip is attached, but instead, advertising indicia 40 are imprinted.

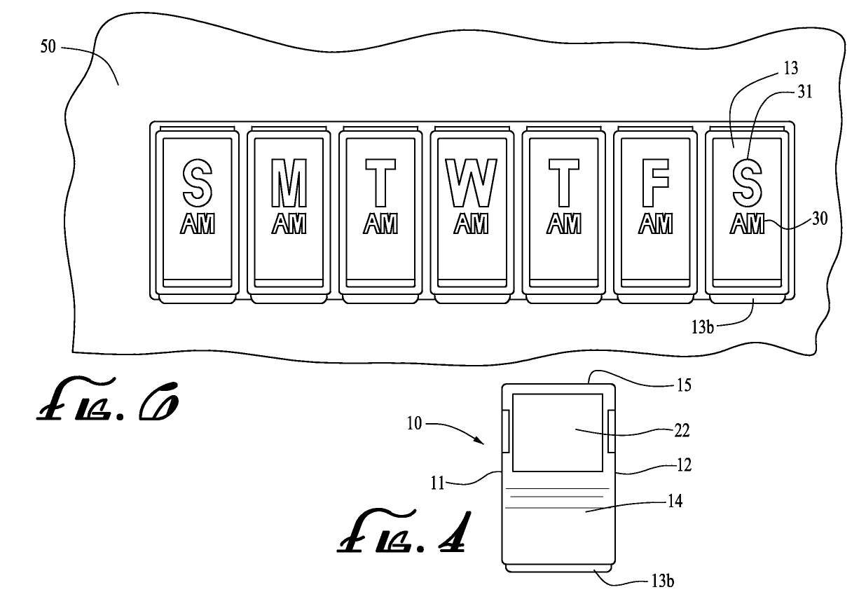

In the second preferred embodiment, as shown in FIG. 4, the magnetic pill case 10 has a thin strip of a permanent magnet 22 attached to the bottom wall 14 which is opposed to the flap 13. Using such a strip 22, a plurality of pill cases can be magnetically attached to an external surface made of ferromagnetic material, even when it is vertical, such as a steel door or refrigerator door. In one embodiment, the magnetic pill case 10 have a means of magnetic attachment such as the permanent magnet strip 22 only on the bottom wall 14 and on no other walls whereby, as shown in FIG. 6, a user can still form a specific array of pill cases following a given administration schedule on an exterior ferromagnetic surface 50. In this embodiment, the pill cases constituting the array are not interconnected to one another, and therefore, when needed, the whole array cannot be moved to another location at once. To provide structural integrity and stability of an array, the pill case 10 may have, in another embodiment, the permanent magnet strip 22 on the bottom wall 14 in addition to the permanent magnet strip 20 and the ferromagnetic strip 21 respectively formed on the right and left walls 11 and 12 so that the pill cases in a particular array may be further connected to one another via the strips 20 and 21 on their right and left walls 11 and 12 while being attached to an exterior surface via the permanent magnet strip 22 on the bottom wall 14.

In still another embodiment, the pill case may further comprise an additional strip of a permanent magnet 23 attached to the rear wall 15, as shown in FIG. 2, so that any two pill cases can be magnetically connected to each other on their rear walls. Preferably, the pill case 10 may have such a permanent magnet strip 23 in addition to the permanent magnet strip 20 and the ferromagnetic strip 21 respectively formed on the right and left walls 11 and 12, or in further addition to the permanent magnet strip 22 on the bottom wall 14. The permanent magnet strip 23 is particularly helpful when, as shown in FIG. 5, 14 pill cases of different combination of the day-of-the-week indicator and time-of-day indicator form two longitudinal arrays, each consisting of 7 serially-connected cases via the permanent magnet strip 20. In this situation, two cases having a same day-of-the-week indicator but different time-of-day indicator may be attached to each other via the permanent magnet strip 23 formed on their respective rear wall to provide further security to the array. In one embodiment, such a permanent magnet strip 23 may be formed on the rear walls of all pill cases constituting a specific pill display. Or in another embodiment, just like the strips 20 and 21 on the right and left walls 11 and 12 in the first preferred embodiment described above, the permanent magnet strip 23 may be slightly protrudingly formed only on half of the pill cases which have, for example, the time-of-day indicator, “AM”, while on the other half which have the time-of-day indicator, “PM”, a ferromagnetic strip in a matching recess may be formed so that two pill cases having a same day-of-the-week indicator may be parallelly connected to each other thereby.

Although the magnetic attaching means formed on the walls of the pill case 10 have been described, in the preferred embodiment, as thin strips of permanent magnet attached to a respective wall, they are not so restricted in the present invention. For example, instead of using a permanent magnet strip, magnetic materials could be directly painted or coated on either a portion or the entire region of the respective wall to attract external ferromagnetic material thereto. The method and magnetic materials used for such magnetic coating or painting are well known in the art, and so, not described herein further.

The present invention is capable of embodiments other than those described above, and its several details are capable of modifications in various respects apparent to those of ordinary skill in the art, all without departing from the essential spirit or attributes of the invention. Therefore, the embodiments described hereinbefore should be considered to be merely illustrative, not restrictive.

What is claimed is:

1. A magnetic pill case for storing medications therein and attaching to at least one ferromagnetic external surface, the case comprising:
identically configured, substantially planar, parallelly opposed right and left walls;
and contiguous and substantially perpendicular thereto, a plurality of boundary walls cooperating with the right and left walls to define an interior of the case, one of the plurality of boundary walls being openable to provide access to the interior of the case; and
a first permanent magnet member formed on one of the plurality of boundary walls that is generally opposing the openable boundary wall for magnetically and removably attaching the case to the at least one external surface ferromagnetic

2. The magnetic pill case as in claim 1, further comprising a second permanent magnet member formed on one of the plurality of boundary walls that is contiguous to the openable boundary wall.

3. The magnetic pill case as in claim 1, wherein the right wall is configured to be magnetically attachable to a left wall of another identical magnetic pill case and the left wall is configured to be magnetically attachable to a right wall of another identical magnetic pill case.

4. The magnetic pill case as in claim 3, wherein a permanent magnet member is formed on the right wall and a ferromagnetic member is formed on the left wall thereof, which are sized and configured such that the permanent magnet member and the ferromagnetic member of the case are magnetically and mateably engageable, respectively, with the ferromagnetic member and the permanent magnet member of anther identical magnetic pill case.

5. The magnetic pill case as in claim 4, wherein the permanent magnetic member is a thin strip of a permanent magnet attached to, and slightly protruding from, the right wall thereof and the ferromagnetic member is a thin strip of ferromagnetic material attached to a bottom of a recess defined on the left wall thereof.

6. The magnetic pill case as in claim 1, wherein the openable boundary wall is a flap hingedly connected, at an edge thereof, to the case.

7. The magnetic pill case as in claim 6, wherein the flap is capable of closing the case by a snap-fit.

8. The magnetic pill case as in claim 1, further comprising a day-of-the-week indicator disposed on the openable top wall.

9. The magnetic pill case as in claim 8, further comprising a time-of-day indicator disposed on the openable top wall.

10. The magnetic pill case as in claim 9, wherein the time-of-day indicator is one of the letters, “AM” and “PM”.

11. A magnetic pill dispenser for selective administration of medications, comprising a plurality of substantially identically sized and configured cases for storing medications therein, each of the plurality of cases comprising:
identically configured, substantially planar, parallelly opposing right and left walls; and contiguous and substantially perpendicular thereto,
a plurality of boundary walls cooperating with the right and left walls to define an interior of the case, one of the plurality of boundary walls being openable to provide access to the interior of the case,
wherein at least two of the plurality of cases further comprise, respectively, a permanent magnet member and a ferromagnetic member respectively formed on the right and left walls thereof, which are sized and configured such that the permanent magnet member in any of the at least two cases is magnetically and mateably engageable with the permanent magnet member in any other of the at least two cases.

12. The magnetic pill dispenser as in claim 11, wherein for each of the at least two cases, the permanent magnetic member is a thin strip of a permanent magnet attached to, and slightly protruding from, the respective right wall thereof and the ferromagnetic member is a thin strip of ferromagnetic material attached to a bottom of a recess defined on the respective left wall thereof.

13. The magnetic pill dispenser as in claim 11, wherein each of the plurality of cases further comprises a first permanent magnet member formed on one of the plurality of boundary walls that is generally opposing the openable boundary wall for magnetically and removably attaching the each case to a ferromagnetic external surface thereby.

14. The magnetic pill dispenser as in claim 13, wherein each of the plurality of cases further comprises a second permanent magnet member formed on one of the plurality of boundary walls that is contiguous to the openable boundary wall.

15. The magnetic pill dispenser as in claim 11, wherein the plurality of cases includes
a first outermost case that has a permanent magnet member formed on the right wall thereof and has no ferromagnetic member formed on the left wall thereof, and
a second outermost case that has no permanent magnet member formed on the right wall thereof and has a ferromagnetic member formed on the left wall thereof.

16. The magnetic pill dispenser as in claim 15, wherein the first and second outermost cases further comprise advertising material imprinted on the left and right walls thereof, respectively, so that the advertising material can be visible when the plurality of cases are magnetically connected in a line with the first and second outermost cases respectively placed at two outermost ends of the line.

17. The magnetic pill dispenser as in claim 11, wherein the openable boundary wall of each of the plurality of cases is a flap hingedly connected, at an edge thereof, to the each case.

18. The magnetic pill dispenser as in claim 17, wherein the flap of each of the plurality of cases is capable of closing the each case by a snap-fit.

19. The magnetic pill dispenser as in claim 11, wherein each of the plurality of cases further comprises a day-of-the-week indicator disposed on the respective openable boundary wall thereof, and there is at least one day-of-the-week indicator that symbolically represents each of the seven days of a week.

20. The magnetic pill dispenser as in claim 19, wherein each of the plurality of cases further comprises a time-of-day indicator disposed on the respective openable boundary wall thereof.

21. The magnetic pill dispenser as in claim 20, wherein the time-of-day indicator on at least half of the plurality of cases comprises the letters “AM”.

22. The magnetic pill dispenser as in claim 20, wherein the time-of-day indicator on at least half of the plurality of cases comprises the letters “PM”.
